(19) United States
(12) Patent Application Publication
(10) Pub. No.: US 2025/0123146 A1
(43) Pub. Date: Apr. 17, 2025

(54) HOLOGRAPHIC GRATING EXPOSURE SYSTEM AND HOLOGRAPHIC GRATING IMAGING SPECTROMETER

(71) Applicants: Tsinghua University, Beijing (CN); HON HAI PRECISION INDUSTRY CO., LTD., New Taipei (TW)

(72) Inventors: JUN ZHU, Beijing (CN); YI-LIN TAN, Beijing (CN)

(21) Appl. No.: 18/911,408

(22) Filed: Oct. 10, 2024

(30) Foreign Application Priority Data
Oct. 17, 2023 (CN) 202311345073.X

(51) Int. Cl. G01J 3/18; G01J 3/02; G01J 3/28

(52) U.S. Cl. CPC G01J 3/1838; G01J 3/021; G01J 3/2823

(57) ABSTRACT

A holographic grating imaging spectrometer, comprises a slit, at least one reflector, a holographic grating, an aperture stop and a detector. The holographic grating is formed on the at least one reflector. The aperture stop is arranged on the at least one reflector. The holographic grating is formed by a holographic grating exposure system. The holographic grating exposure system comprises a first coherent light source, a second coherent light source and at least one freeform surface auxiliary mirror. The at least one freeform surface auxiliary mirror is arranged between the first coherent light source and the at least one reflector.

### CROSS-REFERENCE TO RELATED APPLICATIONS

This application claims all benefits accruing under 35 U.S.C. § 119 from China Patent Application No. 202311345073.X, filed on Oct. 17, 2023, in the China National Intellectual Property Administration, the contents of which are hereby incorporated by reference.

### FIELD

The present disclosure relates to optics field, and in particular to a holographic grating exposure system and a holographic grating imaging spectrometer.

### BACKGROUND

In recent years, imaging spectrometers have been widely used in scientific research, resource exploration, agriculture, food safety, and medicine. Among them, grating imaging spectrometers are the most widely used form of imaging spectroscopic optical structures, and are favored for their reliability and practicality.

The grating in the grating imaging spectrometer can be made by a mechanical ruling method. However, it is difficult to make a variable line spacing grating described by a complex groove line equation by mechanical ruling, and it is difficult to make a high-density grating, so the resolution is low, and the performance and imaging quality of the grating imaging spectrometer are average.

### BRIEF DESCRIPTION OF THE DRAWINGS

Implementations of the present technology will now be described, by way of example only, with reference to the attached figures, wherein:

FIG. 1 is an imaging optical path diagram of a holographic grating imaging spectrometer.

FIG. 2 is an optical path diagram of an exposure system of a holographic grating in a holographic grating imaging spectrometer.

FIG. 3 is a wave aberration diagram of a holographic grating imaging spectrometer.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “comprise, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly comprise at least one of the features. The term of “multiple times” means at least two times, such as two times, three times, etc., unless otherwise expressly and specifically defined.

The present disclosure provides a holographic grating exposure system, which comprises: two coherent light sources and at least one freeform surface auxiliary mirror, wherein the freeform surface auxiliary mirror is arranged between one coherent light source and a holographic grating substrate reflector. The holographic grating substrate reflector is a reflector for forming a holographic grating.

The present disclosure provides a holographic grating, wherein the holographic grating is formed by a holographic grating exposure system.

The present disclosure provides a holographic grating imaging spectrometer, which comprises: a slit, at least one reflector, a holographic grating, an aperture stop and a detector, the holographic grating is formed on the at least one reflector, the aperture stop is arranged on the at least one reflector, the holographic grating is formed by the holographic grating exposure system, the holographic grating exposure system comprises two coherent light sources and at least one freeform surface auxiliary mirror, wherein the freeform surface auxiliary mirror is arranged between one coherent light source and the at least one reflector.

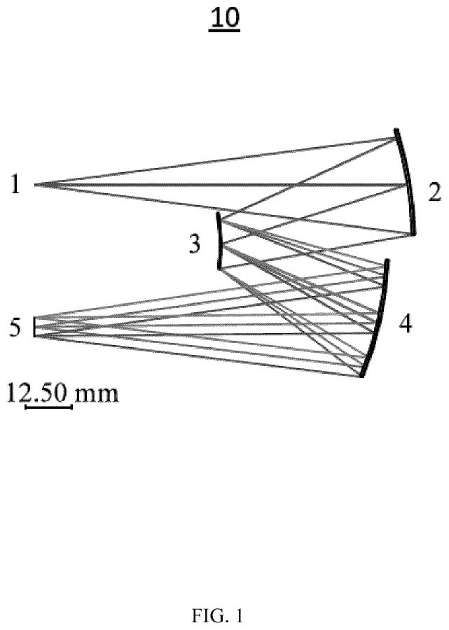

Please refer to FIG. 1, a holographic grating imaging spectrometer 10 is provided in the first embodiment of the present disclosure. The holographic grating imaging spectrometer 10 comprises a slit 1, a primary reflector 2, a secondary reflector 3, a third reflector 4, a holographic grating (not shown), an aperture stop (not shown) and a detector 5 (image plane I). The primary reflector 2, the secondary reflector 3 and the third reflector 4 are all freeform reflectors. The holographic grating and the aperture stop are both arranged on the secondary reflector 3. The light emitted by the object at the slit 1 is incident on the secondary reflector 3 after being reflected by the primary reflector 2. Light of different wavelengths is dispersed on the holographic grating, and then reflected by the third reflector 4, and finally forms a spectral image of the object at the slit on the detector 5 (image plane I).

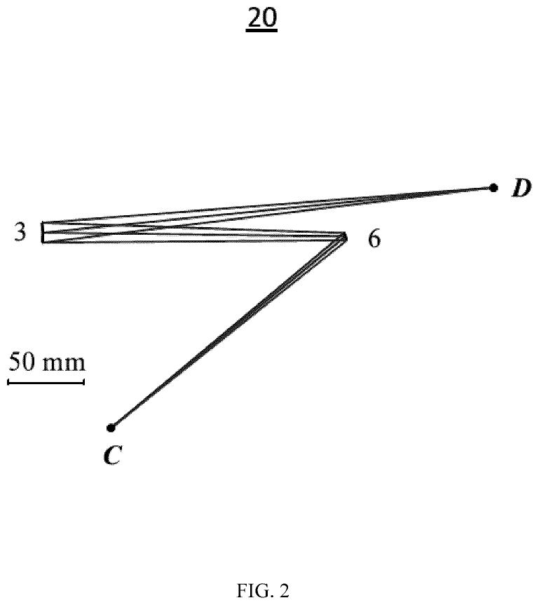

The holographic grating is formed by an exposure system 20. Please refer to FIG. 2. The exposure system 20 comprises two coherent light sources C and D and a freeform surface auxiliary mirror 6. The freeform surface auxiliary mirror 6 is arranged between the light source C and the secondary reflector 3 (holographic grating substrate reflector), and no auxiliary mirror is arranged between the other light source D and the secondary reflector 3 (holographic grating substrate reflector). The wavefront emitted by the light source C is adjusted by the freeform surface auxiliary mirror 6 and interferes with the wavefront of the other light source D on the secondary reflector 3 (holographic grating substrate reflector) and is recorded as a holographic grating, that is, a holographic grating is formed on the secondary reflector 3 (holographic grating substrate reflector).

In one embodiment, the holographic grating imaging spectrometer 10 has a numerical aperture (NA) of 0.13, an imaging spectrum range in the visible light band, i.e., 400-800 nm, a slit length of 10 mm, and a spectral dispersion of 80 nm/mm.

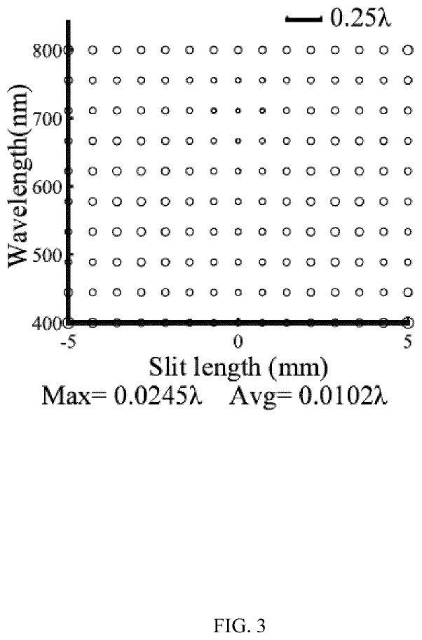

The wave aberration of the holographic grating imaging spectrometer 10 is shown in FIG. 3, and the average wave aberration (RMS WFE) is 0.0102 λ, which has reached the diffraction limit. The spectral line bending (Smile) of the holographic grating imaging spectrometer 10 is 1.4 μm, and the chromatic distortion (Keystone) is 2.0 μm. Finally, the holographic grating imaging spectrometer 10 achieves good imaging quality and small distortion, and improves the performance of the holographic grating imaging spectrometer 10.

It can be understood that the main reflector 2, the secondary reflector 3, and the third reflector 4 are not limited to freeform surface reflectors, but can also be spherical reflectors, quadratic reflectors, aspherical reflectors, etc. The surface shapes of the main reflector 2, the secondary reflector 3, and the third reflector 4 can be the same or different. Moreover, the holographic grating and the aperture stop are not limited to being set on the secondary reflector 3, but can also be set on the main reflector 2 or the third reflector 4, and the holographic grating and the aperture stop are not limited to being set on the same reflector.

The structure of the exposure system is not limited to the structure of the present embodiment. The exposure system may also comprise two coherent light sources, wherein a freeform surface auxiliary mirror is provided between one of the light sources and the secondary reflector (holographic grating substrate reflector), and an auxiliary mirror may also be provided between the other light source and the secondary reflector (holographic grating substrate reflector). The curved surface of the auxiliary mirror may be a spherical surface, a quadratic surface, an aspherical surface or a freeform surface, etc.

The second embodiment of the present disclosure provides a holographic grating imaging spectrometer. The holographic grating imaging spectrometer comprises a slit, a primary reflector, a secondary reflector, a holographic grating, an aperture stop and a detector (image plane I). The primary reflector is a freeform surface reflector, the secondary reflector is a spherical reflector, the holographic grating is provided on the primary reflector, and the aperture stop is provided on the secondary reflector. The light emitted by the object at the slit 1 is incident on the primary reflector, and the light of different wavelengths is dispersed on the holographic grating, and then reflected by the secondary reflector, and finally forms a spectral image of the object at the slit on the detector (image plane I).

The holographic grating is formed by an exposure system, which comprises two coherent light sources, wherein a freeform surface auxiliary mirror is arranged between one of the light sources and the secondary reflector (holographic grating substrate reflector), and an auxiliary mirror is arranged between the other light source and the secondary reflector (holographic grating substrate reflector), and the curved surface of the auxiliary mirror is spherical. The wave surface emitted by one light source is adjusted by the freeform surface auxiliary mirror, and interferes with the wave surface emitted by another light source on the secondary reflector (holographic grating substrate reflector) after being adjusted by the spherical auxiliary mirror and recorded as a holographic grating, that is, a holographic grating is formed on the secondary reflector (holographic grating substrate reflector).

It can be understood that the surface shapes of the primary reflector and the secondary reflector are not limited to this, and can also be other surface shapes, for example, they can also be spherical, quadratic, aspherical, freeform, etc. The surface shapes of the primary reflector and the secondary reflector can be the same or different. Moreover, the holographic grating is not limited to being arranged on the primary reflector, but can also be arranged on the secondary reflector. The aperture stop is not limited to being set on the secondary reflector, but can also be set on the primary reflector. Moreover, the holographic grating and the aperture stop can also be set on the same reflector.

The structure of the exposure system is not limited to the present embodiment, and can also comprise two coherent light sources, wherein a freeform surface auxiliary mirror is set between one of the light sources and the secondary reflector (holographic grating substrate reflector), and no auxiliary mirror is set between the other light source and the secondary reflector (holographic grating substrate reflector), or an auxiliary mirror can be set. If an auxiliary mirror is set, the surface shape of the auxiliary mirror can be a spherical surface, a quadratic surface, an aspherical surface, or a freeform surface, etc.

It can be understood that the number of reflectors in the holographic grating imaging spectrometer of the present disclosure is not limited, and can comprise multiple reflectors, and the multiple reflectors can be spherical reflectors, quadratic reflectors, aspherical reflectors, or freeform reflectors, etc. Preferably, at least one of the multiple reflectors is a freeform surface reflector, and more preferably, the multiple reflectors are all freeform surface reflectors.

It can be understood that the exposure system comprises two coherent light sources, wherein a freeform surface auxiliary mirror is arranged between one of the light sources and the holographic grating substrate reflector, and an auxiliary mirror may or may not be arranged between the other light source and the holographic grating substrate reflector. If an auxiliary mirror is arranged, the curved surface of the auxiliary mirror may be a spherical surface, a quadratic surface, an aspherical surface, or a freeform surface, etc. Preferably, the curved surface of the auxiliary mirror is a freeform surface.

The holographic grating exposure system provided by the present disclosure comprises two coherent light sources and at least one freeform surface auxiliary mirror, wherein a freeform surface auxiliary mirror is arranged between a light source and the holographic grating substrate reflector. After being adjusted by the freeform surface auxiliary mirror, the wavefront emitted by one light source interferes with the wavefront emitted by another light source on the holographic grating substrate reflector and is recorded as a holographic grating, that is, a holographic grating is formed on the holographic grating substrate reflector. Therefore, the holographic grating can achieve higher free parameters, thereby having the ability to correct higher-order aberrations. The holographic grating imaging spectrometer of the present disclosure comprises a holographic grating with freeform surface exposure realized by a freeform surface auxiliary mirror, so the holographic grating can realize higher free parameters, thereby having the ability to correct higher-order aberrations, and thus the holographic grating imaging spectrometer has higher performance and better imaging quality.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may comprise some indication in reference to certain steps. However, the indication used is only to be viewed for identification purposes and not as a suggestion as to an order for the steps.

What is claimed is:

1. A holographic grating imaging spectrometer, comprising:
a slit, at least one reflector, a holographic grating, an aperture stop and a detector, wherein the holographic grating is formed on the at least one reflector, the aperture stop is arranged on the at least one reflector, and the holographic grating is formed by a holographic grating exposure system, the holographic grating exposure system comprises a first coherent light source, a second coherent light source and at least one freeform surface auxiliary mirror, the at least one freeform surface auxiliary mirror is arranged between the first coherent light source and the at least one reflector.

2. The holographic grating imaging spectrometer of claim 1, further comprising an auxiliary mirror, wherein the auxiliary mirror is arranged between the second coherent light source and the at least one reflector.

3. The holographic grating imaging spectrometer of claim 2, wherein a surface of the auxiliary mirror is a spherical surface, a quadratic surface, an aspherical surface, or a freeform surface.

4. The holographic grating imaging spectrometer of claim 1, wherein the at least one reflector is a freeform surface reflector.

5. The holographic grating imaging spectrometer of claim 1, wherein the at least one reflector comprises a plurality of reflectors, and the plurality of reflectors are spherical reflectors, quadratic reflectors, aspherical reflectors or freeform reflectors.

6. The holographic grating imaging spectrometer of claim 1, wherein the at least one reflector comprises a primary reflector, a secondary reflector and a third reflector, the holographic grating and the aperture stop are both arranged on the secondary reflector, and a light emitted by an object at the slit is incident on the secondary reflector after being reflected by the primary reflector, and light of different wavelengths is dispersed on the holographic grating, then is reflected by the third reflector, and finally forms a spectral image of the object at the slit on the detector.

7. The holographic grating imaging spectrometer of claim 6, wherein the primary reflector, the secondary reflector and the third reflector are all freeform surface reflectors.

8. A holographic grating exposure system, comprising:
a first coherent light source, a second coherent light source and at least one freeform surface auxiliary mirror, wherein the holographic grating exposure system is configured to form a holographic grating on a holographic grating substrate reflector, and the freeform surface auxiliary mirror is arranged between the first light source and the holographic grating substrate reflector.

9. The holographic grating exposure system of claim 8, further comprising an auxiliary mirror, wherein the auxiliary mirror is arranged between the second coherent light source and the holographic grating substrate reflector.

10. The holographic grating exposure system of claim 9, wherein a surface of the auxiliary mirror arranged between the second coherent light source and the said holographic grating substrate reflector is a spherical surface, a quadratic surface, an aspherical surface or a freeform surface.
